(19) United States
(12) Patent Application Publication
(10) Pub. No.: US 2011/0313736 A1
(43) Pub. Date: Dec. 22, 2011

(54) Method and Algorithm for Modeling and Simulating A Discrete-Event Dynamic System

(75) Inventors: Lenrick Johnston, Berkeley, CA (US); David Zhang, Berkeley, CA (US); Lee Schruben, Berkeley, CA (US)

(73) Assignee: Bioproduction Group, a California Corporation

(21) Appl. No.: 12/819,173

(22) Filed: Jun. 18, 2010

(51) Int. Cl. G06F 17/10

(52) U.S. Cl. 703/2

(57) ABSTRACT

A method for modeling, visualizing and simulating a large-scale discrete-event dynamic system, comprising the steps of expressing an algorithm that models a plurality of activity interactions, determining a plurality of possible relationships between a plurality of system elements including transient entities, resident entities, or both, providing a hierarchical mapping of the plurality of system elements and the plurality of possible relationships among the plurality of system elements, representing a relationship diagram as a graph notation where an activity or a system element is visualized as a node and the plurality of possible relationships among the activity or the system element as an arc, allowing an explicit description of the plurality of possible relationships among the activity or the system element and a plurality of possible ways in which the activity can begin and a sequence of activities, and representing an activity interaction matrix that categorizes the plurality of activity interactions.

### BACKGROUND OF THE INVENTION

1. Technical Field of the Invention

The present invention relates to a method for discrete-event dynamic system simulation. More specifically, the present invention relates to a method and algorithm for modeling and visualization of a large-scale system having a plurality of indirectly linked processes.

2. Description of the Related Art

Discrete-event simulation is a common generic methodology for modeling systems that has been used for decades in modeling real-world human enterprises including systems for communication, transportation, production, health care, etc. Discrete-event simulation modeling has also been utilized to optimize decision making associated with designing new processes, products, or manufacturing techniques. Important dependencies and performance characteristics of a process are captured in a discrete-event dynamic system simulation, which can then be used to explore the effects of making changes to the process.

Traditional discrete-event simulation of a dynamic system entails simulating events in time order, beginning at some initial simulated time and progressing forward in time. There have been a number of methods for modeling and implementing discrete-event simulations including activity scanning (resident entity cycle diagrams), process interaction (entity flow diagrams), and event scheduling discrete event simulation paradigms (event graphs).

A process-based modeling approach provides an efficient simulation by employing a highly efficient ordering of the events to be simulated. Specifically, the events to be simulated are grouped into layers and the layers are simulated in order. Each of the layers consists of events that are either strictly independent of the other events in the layer or are dependent on other events in the layer but possess a particular attribute. That attribute is one that permits the use of an associative operator. This operator allows the simulation of N events in O (log N) computation iterations. The downside to this process-based modeling approach is that it does not easily allow a very large sequence of possible processes to be modeled, when the processes are highly dependent and share many common attributes. Since most common real-world systems are highly inter-dependent, this limits the applicability of such a process-based approach.

There are several entity-based discrete-event simulation modeling frameworks that were designed and developed to extend the accuracy of available simulation tools. Such models explicitly consider the flow of entities—such as batches or jobs—through a system, allowing very complex systems to be modeled. However, an entity flow modeling view does not explicitly show indirect causality describing how processes might cause other processes other than through a transient entity. This is critical in modeling systems where many processes are indirectly linked, despite not being explicitly modeled as such. Finally, a major limitation of a transient entity flow path simulation model is that it does not scale well to highly congested systems since the approach requires explicit tracking of individual entities in the system. As more and more transient entities enter, a process flow model will execute very slowly, precluding use in large-factor ‘design of experiments’ commonly used for analysis for complex systems.

In order to address the need for an optimistic discrete-event simulation approach, a method has been developed for synchronous parallel environments for emulation and discrete event simulation. The method utilizes a technique called breathing time buckets (BTB), which uses some of the conservative techniques of time-bucket synchronization, along with some of the optimistic techniques of the time-warp approach. Such a technique does not consider a concurrent interaction of the system elements including transient as well as resident entities and contention of an activity.

Hence, it can be seen that there is a need for an accurate and fast method for simulating a discrete-event dynamic system having many indirectly linked processes, including a very large sequence of possible processes all of which may happen in parallel. The method would need to identify a priori the relationships between these processes in order to exclude unrelated process relationships from consideration. Further, the needed method would scale to allow the modeling of highly congested systems, without a significant slow-down that may preclude user experimentation, optimization or design-of-experiment type approaches. Moreover, the needed method would consider a concurrent interaction of the system elements including transient as well as resident entities and contention of activities, as well as variability in activity timing or entities throughout the simulation.

### SUMMARY OF THE INVENTION

The present invention provides a method for modeling, visualizing and simulating a large-scale discrete-event dynamic system, comprising the steps of expressing an algorithm that models a plurality of activity interactions in a discrete-event dynamic system, determining a plurality of possible relationships between a plurality of system elements including transient entities, resident entities, or both associated in the discrete-event dynamic system, providing a hierarchical mapping of the plurality of system elements and the plurality of possible relationships among the plurality of system elements, representing a relationship diagram as a graph notation where an activity or a system element is visualized as a node and the plurality of possible relationships among the activity or the system element as an arc, allowing an explicit description of the plurality of possible relationships among the activity or the system element and a plurality of possible ways in which the activity can begin and a sequence of activities that may occur during and after the completion of the activity, and representing an activity interaction matrix used to describe and categorize the plurality of activity interactions. The simulation can then be executed so as to only consider these relationships and ignore possible interactions, which are in practice infeasible.

In another aspect of the present invention, in accordance with the present invention is a method and an algorithm for determining a plurality of possible relationships between a plurality of activities caused by a set of shared system elements, comprising the steps of representing a relationship diagram as a graph notation where an activity or a system element is visualized as a node and a plurality of possible relationships among the activity or the system element as an arc wherein the system elements including transient entities, resident entities, or both associated in a discrete-event dynamic system, initializing the algorithm with an empty set of activity-to-activity pairs S(k) requiring a system element k, k=1 . . . K; populating S(k) with a set of activity-to-activity pairs containing a list of arcs in the relationship diagram relating to the system element k; initializing a variable C(a) which is defined as the total number of status value conditions to start an activity a for each a=1 . . . A; for each start of activity a, a=1 . . . A, iterating over a set of possible activities with changes in a set of system element status values for each activity b, b=1 . . . B; initializing a variable N(a,b) for each activity to activity pair {a, b} that is defined as the total number of status value conditions satisfied by the activity a, by changes in the set of system element status values caused by the activity b; iterating over each system element k=1 . . . K in order to determine N(a,b); determining if an activity a requires the system element k to start and then, determining if a status value condition j becomes true through change of the system element k so as to increment Nab as Nab=Nab+1 and append the arc {a,b} to the set S, S(k)=S(k) U {a, b}; and comparing N(a,b), the total number of status value conditions satisfied against the total number of status value conditions C(a) after iterating through a set of possible system elements and a set of status value conditions on the activity a, wherein if N(a,b)=C(a) then the set of possible status value conditions are satisfied and the activity b is considered to be sufficient to start the activity a, if N(a,b)=0 then the activity b is unrelated to the activity a, and If 0<N(a,b)<C(a) then at least one of the status value conditions to start the activity a is satisfied by the activity b.

A first objective of the present invention is to provide an accurate and complete method for simulating a discrete-event dynamic system which considers a concurrent interaction of a plurality of system elements and contention of a plurality of activities while excluding non-interacting elements and activities and thereby enabling fast simulation and modeling of a large-scale system having a plurality of indirectly linked activities or processes.

A second objective of the invention is to provide a method for modeling a discrete-event dynamic system that treats every possible logical and physical component of that system—including transient entities, resident entities, or both—identically as a system element in modeling and simulating complex relationships between the sequence of activities and a plurality of system elements in the discrete-event dynamic system.

A third objective of the invention is to provide a method for modeling and simulating a discrete-event dynamic system wherein an activity is considered as any dynamic interaction of a plurality of system elements of any duration.

A fourth objective of the invention is to provide a method for expressing an algorithm that models a plurality of activity interactions in a discrete-event dynamic system.

A fifth objective of the invention is to relate a relationship diagram that is used for at least one of activity sequencing, contention for a plurality of system elements among different activities, concurrent system elements required by activities, and visualization of a simulation.

A sixth objective of the invention is to represent a relationship diagram as a graph notation where an activity or a system element is visualized as a node and a plurality of possible relationships among the activity or the system element as an arc.

A seventh objective of the invention is to provide a method for representing an activity interaction matrix that is used to categorize a plurality of activity interactions.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is an operational flow chart of an algorithm that models a plurality of activity interactions in the discrete-event dynamic system according to the present invention;

FIG. 2 is an example of a carwash process for illustrating a relationship diagram as a graph notation;

FIG. 3 is an example activity interaction matrix used to categorize the plurality of activity interactions based on the example of the carwash process shown in FIG. 2;

FIG. 4 shows a starting condition for a specific activity and resulting system element changes caused by the segmentation of the relationship diagram;

FIG. 5 is a ‘successor activity to activity’ relationship diagram for implementing the activity interaction matrix;

FIG. 6 is a ‘predecessor activity to activity’ relationship diagram for implementing the activity interaction matrix;

FIG. 7 is a ‘predecessor and successor activity to activity’ relationship diagram for implementing the activity interaction matrix;

FIG. 8 is a sample of an ‘predecessor and successor activity to activity’ relationship diagram of FIG. 7 where the entities required to start the activity and released by the activity are indicated on the arcs based on FIG. 2;

FIG. 9 is a ‘predecessor and successor activity to activity’ relationship diagram of FIG. 7 that shows comparative number of a total number of status value conditions satisfied by an activity to a total number of status value conditions to start the activity;

FIG. 10 is an ‘activity to entity’ relationship diagram implementing a visualization of the activity interaction matrix based on the example in FIG. 2;

FIG. 11 is an ‘entity to activity’ relationship diagram implementing a visualization of the activity interaction matrix; and

FIG. 12 is an ‘activity to entity to activity’ relationship diagram implementing one possible visualization of the activity interaction matrix.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

It should be appreciated that the present application presents certain terminology that is shared with Active Scanning technology; however, Active Scanning technology encompasses a separate class of algorithms (e.g. the ‘three-phase’ method) that operate in fixed time increments and are not true discrete-event simulations.

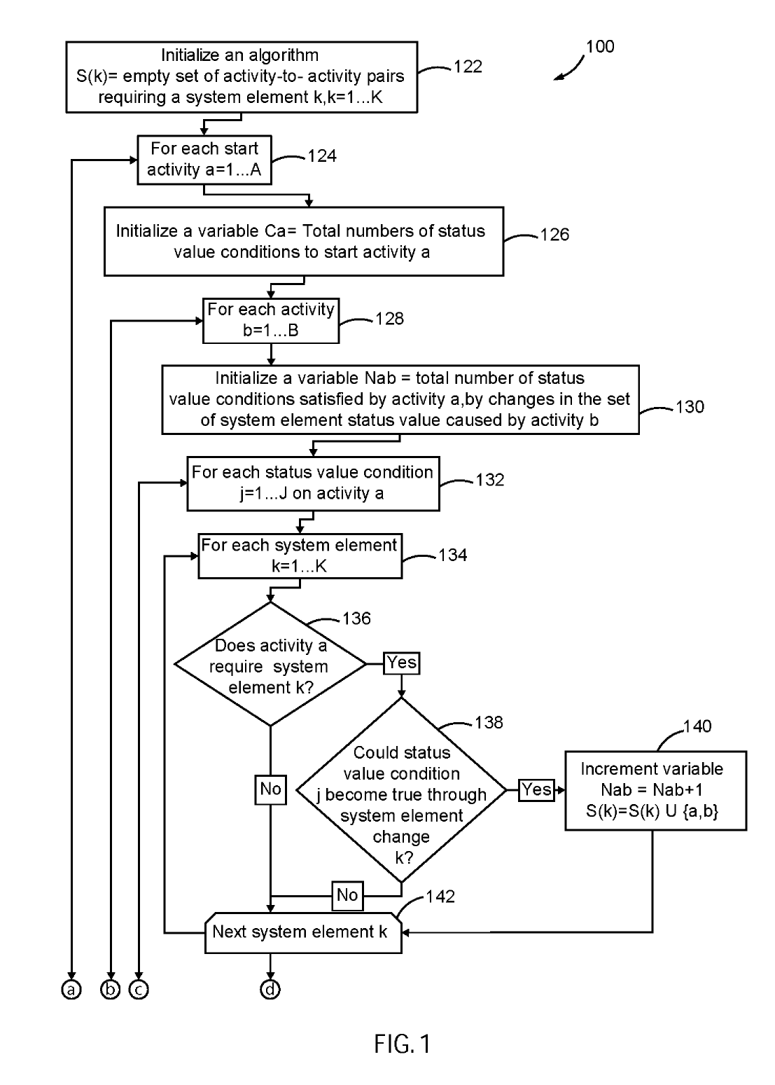

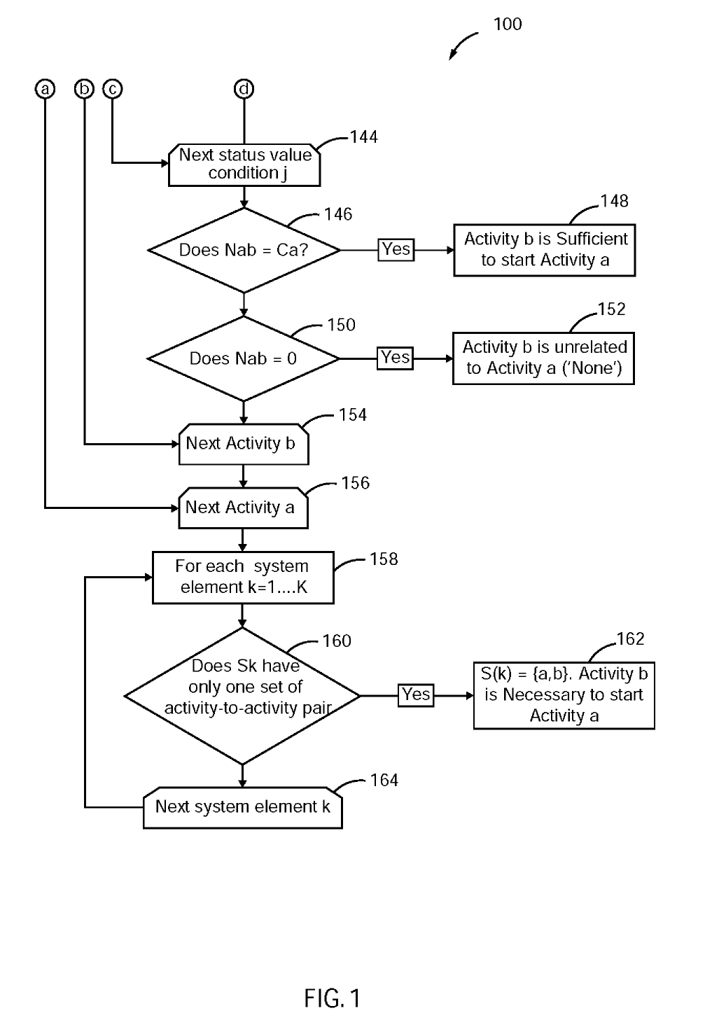

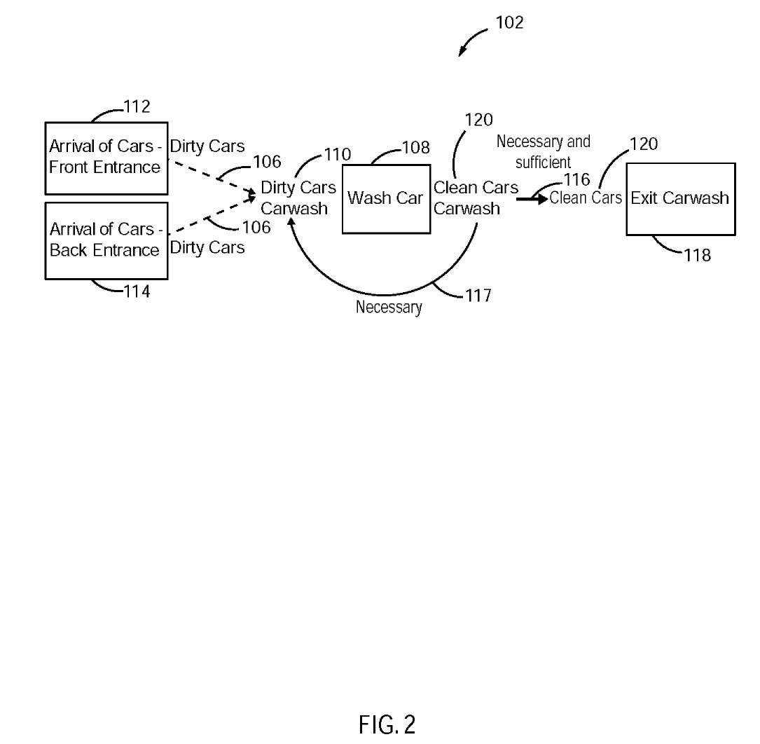

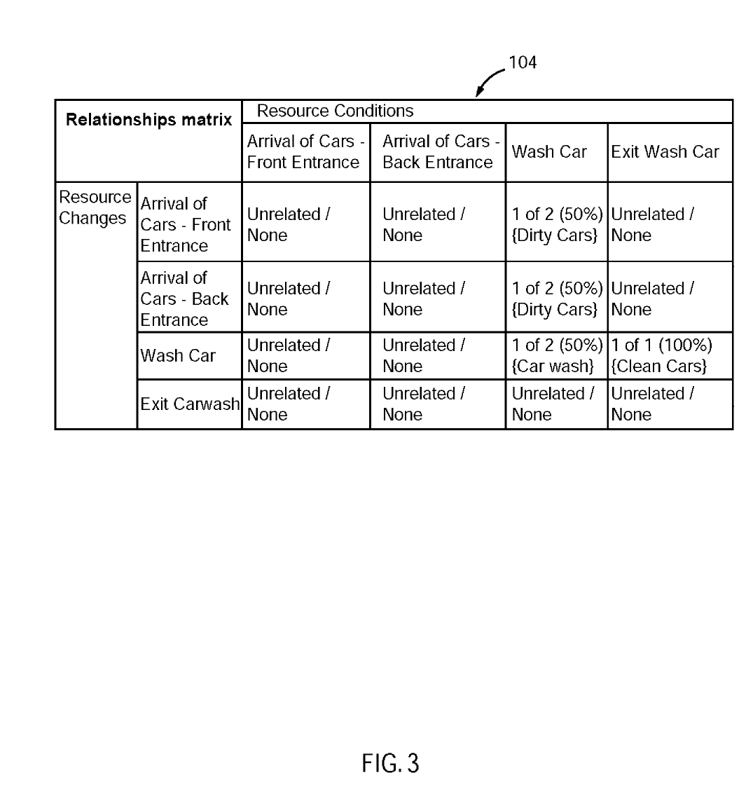

Turning first to FIG. 1, a method for modeling and simulating a discrete-event dynamic system, comprises the steps of expressing an algorithm 100 that models a plurality of activity interactions in the discrete-event dynamic system, determining a plurality of possible relationships between a plurality of system elements including transient entities, resident entities, or both associated in the discrete-event dynamic system both explicit and implied using the algorithm 100, and providing a hierarchical mapping of the plurality of system elements and the plurality of possible relationships among the plurality of system elements. Further, the method includes the steps of representing a relationship diagram 102 as shown in FIG. 2 as a graph notation where an activity or a system element is visualized as a node and the plurality of possible relationships among the activity or the system element as an arc, allowing an explicit description of the plurality of possible relationships among the activity or the system element and a plurality of possible ways in which the activity can begin and a sequence of activities that may occur during and after the completion of the activity, and representing an activity interaction matrix 104 as shown in FIG. 3 used to describe and categorize the plurality of activity interactions.

The relationship diagram 102 of the present invention treats every possible logical and physical component including transient entities, resident entities, or both identically as the system element in modeling and simulating complex relationships between the sequence of activities and the plurality of system elements in the discrete-event dynamic system. The relationship diagram 102 may be used for at least one of activity sequencing, contention for the plurality of system elements among different activities, concurrent system elements required by activities, and visualization of the simulation.

The present method considers a concurrent interaction of the plurality of system elements and contention of the activity thereby enabling fast simulation and modeling of a large-scale system having a plurality of indirectly linked processes. Every change in the system element is modeled by the changes in a set of status values that includes a plurality of possible physical state and a plurality of possible logical state of the discrete-event dynamic system at any point in time.

According to the present invention, the activity can be any dynamic interaction of the system element of any duration. The activity is considered as initiated when the set of status values of a specific set of system elements is within a specified set of status values. Likewise, the activity is considered as completed when the set of status values of the specific set of system elements enters another specified set of status values. This set of status values may include any general combination of times, general logical conditions or other characteristics of the system.

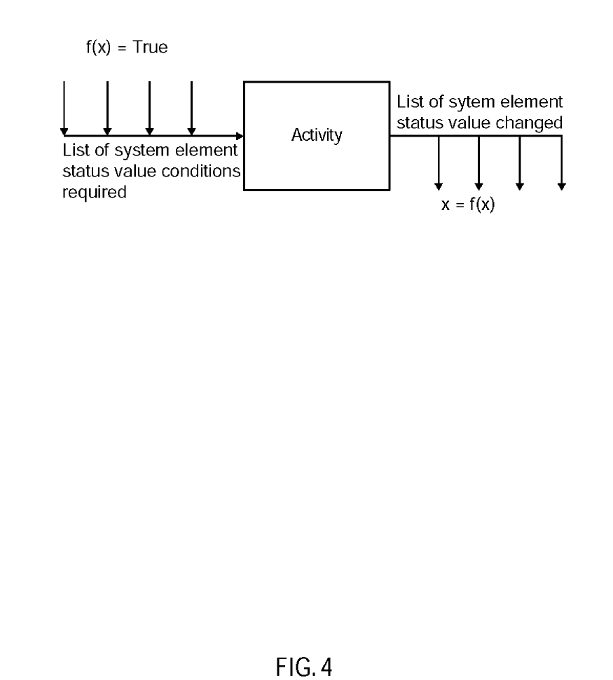

For a specific activity, the relationship diagram 102 segments the plurality of system elements interacting in the specific activity into a list of system element status value conditions required to initiate the specific activity and a list of system element status values changed as a result of the specific activity occurring (either at the start of or during the specific activity). FIG. 4 shows a starting condition for a specific activity by the segmentation of a relationship diagram 102 where x is the vector of current element status values at a particular point in the execution of the simulation. The starting condition for the specific activity by the segmentation of the relationship diagram 102 can be represented as:

$${\prod }_{i} {I}_{j} ( {f}_{i} ( x ) = true ) = 1$$

where x is the vector of a current system elements at a particular point in the execution of the simulation of an activity j, f(x) is the status value conditions on the system elements that must all be true in order to initiate the activity j, and Ij(fᵢ(x)=true) is an indicator function for the activity j when a status value condition i is true. This equation requires that all the conditions to start an activity must be met for that activity to initiate.

Further, at the initiation and during execution of the activity j, one or more changes can occur to the set of status values which may cause a set of another activities to be placed on a pending activity list that can be described as:

$${\prod }_{i} {I}_{k} ( {f}_{i} ( x + X ) = true ) = 1$$

where X is the vector of changes to system elements caused by activity j, k is an activity that is scheduled due to the activity j when at least one of the status value conditions for commencing activity k may be met by the execution of the activity j.

The relationship diagram 102 categorizes the plurality of activity interactions as one of sufficient, necessary, insufficient or unrelated on the basis of the set of status values of the system element. A specific activity-to-activity pair is considered to be sufficient if the specific activity makes at least one of the status value conditions that are sufficient to start another activity. A specific activity to activity pair is considered to be necessary if the specific activity has at least one of the status value conditions that are required to start another activity and when the specific activity is the only dependable activity in the simulation to trigger the start of that other activity. A specific activity-to-activity pair is considered to be insufficient if the specific activity is neither necessary nor sufficient, but has at least status value conditions that may trigger the start of that other activity. If none of these conditions are true, the activity to activity pair is considered unrelated and can be excluded from consideration in a simulation.

In order to explain the key differences between the sufficient activity, necessary activity, and insufficient activity relationships, the notation in FIG. 2 shows an example of a carwash process for illustrating the relationship diagram 102 as the graph notation. In this illustration the plurality of system element conditions required to start the activity are denoted on the left of the activity (which are the elements required to start the activity in this case), and the plurality of system element value changes caused by this activity are denoted on the right (which are elements becoming available after the activity completes in this case).

In the example car wash process, a pair of dashed arrows 106 indicates the plurality of possible relationships between an end of the activities 112 and 114 and the possible start of another activity 108 which are neither the necessary nor sufficient (that is, insufficient). A wash car activity 108 requires two system elements or status values 110, dirty cars and carwash. One of the system elements or the status values called dirty cars 110 are produced by two exogenous activities: arrival of cars-front entrance 112 and arrival of cars-back entrance 114. An arc 117 is also drawn between the end of the wash car activity 108 and a start of another wash car activity. This is a necessary condition since this is the only place where a carwash bay is released in the simulation, but having a carwash bay is not sufficient to start the wash car activity 108 as there might not be any dirty cars waiting. Finally a boldface arrow 116 is drawn between the wash car activity 108 and an exit carwash activity 118. The boldface arrow 116 is both necessary and sufficient since clean cars 120 are the only requirement in order to perform the exit carwash activity 118, and cars are changed to this status at the end of the wash car activity 108.

Referring to FIG. 1 a method and an algorithm 100 for determining the plurality of possible relationships between a plurality of activities caused by a set of shared system elements comprises the steps of representing the relationship diagram 102 as the graph notation where the activity or system element is visualized as the node and the plurality of possible relationships among the activity or the system elements as a number of arcs wherein the system elements include transient entities, resident entities, or both associated in the discrete-event dynamic system as well as a general logical relationship between entity states. The algorithm 100 initializes with an empty set of activity-to-activity pairs S(k) requiring a system element k, k=1 . . . K as shown in block 122, populating S(k) with a set of activity-to-activity pairs containing a list of arcs in the relationship diagram 102 relating to the system element k for each start of the activity a, a=1 . . . A. As shown in block 124, a variable C(a) is defined as the total number of status value conditions required to start an activity a as shown in block 126. C(a) is known prior to the execution of the simulation.

Further, the method and the algorithm 100 comprises the steps of initializing a variable N(a,b) to 0 as shown in block 130 for each of the set of activity-to-activity pairs {a, b} wherein N(a,b) is defined as the total number of status value conditions satisfied by the activity a by changes in the set of system element status values caused by the activity b. The value of N(a,b) is determined for each activity-to-activity pair {a, b} by iterating over the list of system element status value conditions j wherein j=1 . . . J as shown in block 132, and iterating over each of the system elements k=1 . . . K as shown in block 134. Thereafter determining if an activity a requires the system element k to start as shown in block 136 and then determining if a status value condition j becomes true through change of the system element k as shown in block 138 so as to increment N(a,b) as N(a,b)=N(a,b)+1 and to increment the specific arc to the set of element specific conditions S(k)=S(k) U {a, b} as shown in block 140. Finally after iterating through a next set of possible system elements as shown in block 142 and a next set of status value conditions j as shown in block 144, the algorithm determines the total number of status value conditions satisfied N(a,b) against the total number of status value conditions C(a) on the activity-to-activity pair {a,b} wherein if N(a,b)=C(a) as shown in block 146, then the set of possible status value conditions are satisfied and the activity b is considered to be sufficient to start the activity a as shown in block 148. If N(a,b)=0 as shown in block 150, then the activity b is unrelated to the activity a as shown in block 152, and if 0<N(a,b)<C(a) then at least one of the status value conditions to start the activity a is satisfied by the activity b. This pattern is repeated for each possible combination of activities {a,b} as shown in block 154 and block 156. After checking every possible combination of activities {a,b} and establishing S(k) in blocks 124 through 156, the algorithm finally checks for each of the system elements k=1 . . . K as shown in block 158. If the S(k) contains only one set of activity-to-activity pairs as shown in block 160, then the activity b is necessary to start activity b as shown in block 162, and if not, continues checking on the system element k as shown in block 164.

The method of the present invention considers a concurrent interaction of the set of shared system elements and contention of possible activities but does not consider activities that are not linked, thereby enabling fast simulation and modeling of a large-scale system having a plurality of indirectly linked processes.

The method and algorithm 100 can be used to illustrate the example of a carwash process shown in FIG. 2, for the system element k=dirty cars. A set S (dirty cars) in this case includes two activity-to-activity pairs that are {arrival of cars-front entrance, wash car) and {arrival of cars-back entrance, wash car). The activity-to-activity pairs represent the pair of dashed arrows 106 in the relationship diagram 102 that involves the system element dirty cars. The wash car activity 108 has two conditions, dirty cars and carwash, so C(a)=2. The set of activity-to-activity pairs {a, b} as {wash car, exit carwash} is examined, then iterated over each of the three possible system elements (dirty cars, carwash, clean cars}. Here the system element clean cars is the only system element required by the exit carwash activity 118, so C(a)=1. Thereafter, the algorithm determines that the condition that at least one clean cars is satisfied through the release of a clean car by the exit carwash activity 118, therefore increments the variable N(a,b) as N(a,b)=1. The arrival of cars-front entrance 112 does not involve the system element carwash. Therefore at least one of the conditions to start the wash car activity 108 is not met, so the activity is not a sufficient relationship.

Finally the set of activity-to-activity pairs {a, b} as {wash car, wash car} is examined. This activity-to-activity pair corresponds to the wash car activity 108 restarting immediately after it has finished, then iterates over each of the three possible elements (dirty cars, carwash, clean cars}. The system element dirty cars as well as the system element carwash is required by the wash car activity 108, therefore C(a)=2. Next a determination is made that the condition that there be at least one carwash is satisfied through the release of a carwash by the end of the wash car activity 108, therefore incrementing the variable N(a,b) as N(a,b)=1. The wash car activity 108 does not involve the element dirty cars, so at least one of the conditions to start the wash car activity 108 is not met, therefore this is not a sufficient relationship. The system element clean cars has only one entry, {wash car, exit carwash}. That is, the exit carwash activity 118 is a necessary activity for wash car activity 108 to start.

The result of the method and algorithm 100 for the example car wash process is the activity interaction matrix 104 shown in FIG. 3 where ‘none’ indicates both C(a) and N(a,b) are 0, X of Y (Z %) indicates N(a,b), C(a), and N(a,b) divided by C(a) respectively.

The activity interaction matrix 104 of the present invention shown in FIG. 3 is generated based on the relationship diagram 102. The activity interaction matrix 104 categorizes the plurality of activity to activity interactions that are possible where each row entry contains the status value changes resulting from the activity and each column entry contains the status conditions required for the start of the activity. Cells contain a list of the elements shared between the activity-activity pairs including an assessment of which interactions are sufficient, necessary, insufficient, and unrelated for modeling and simulating complex relationships between the plurality of activities. The plurality of system elements in the discrete-event dynamic system comprises the steps of determining—for a particular activity—if the list of system element status value conditions are true entirely, then stating the starting condition for the activity as sufficient, determining if the activity has at least one of the status value conditions that are required to start another activity and if the activity is the only dependable activity for the another activity, then stating the starting condition for the activity as necessary, determining if the activity has at least one of the status value conditions that are required to start another activity but does not fall into the category of necessary activity and sufficient activity, then stating the starting condition for the activity as insufficient, and finally determining if none of the other conditions are true that the starting condition for the activity as unrelated to the activity.

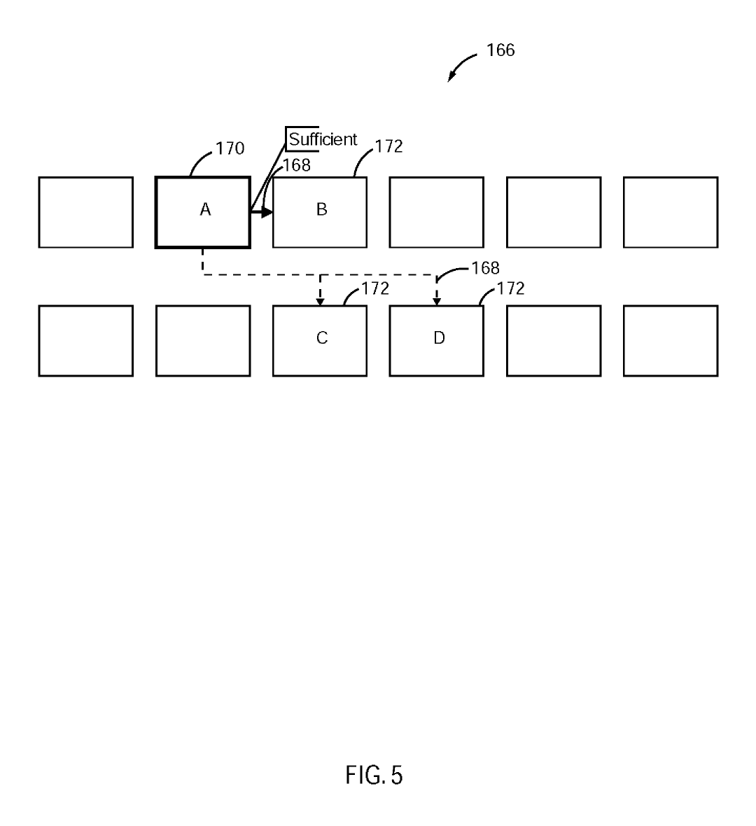

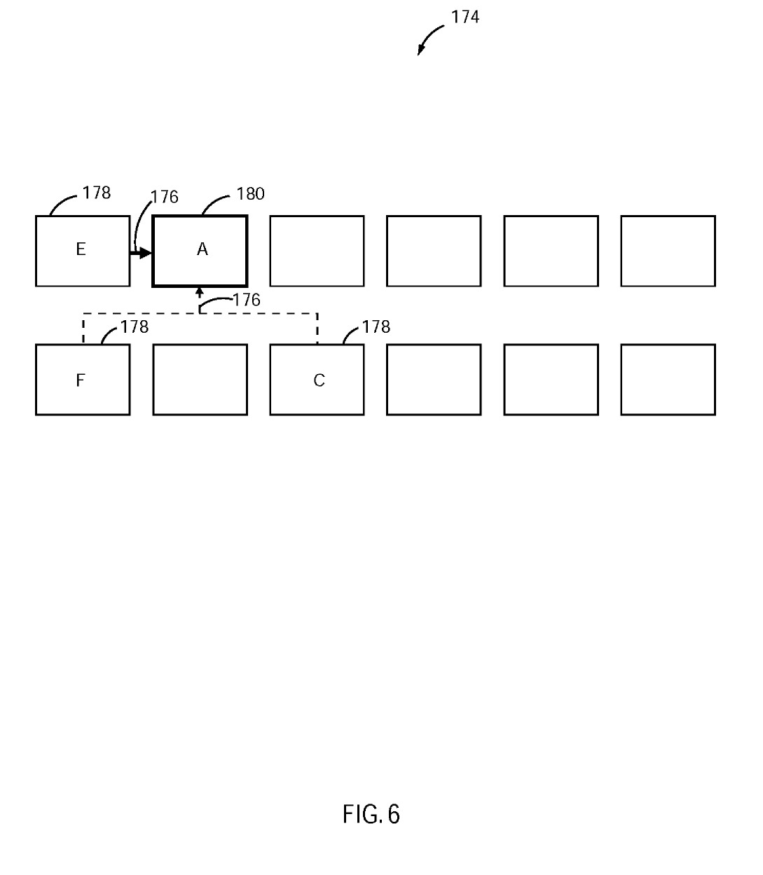

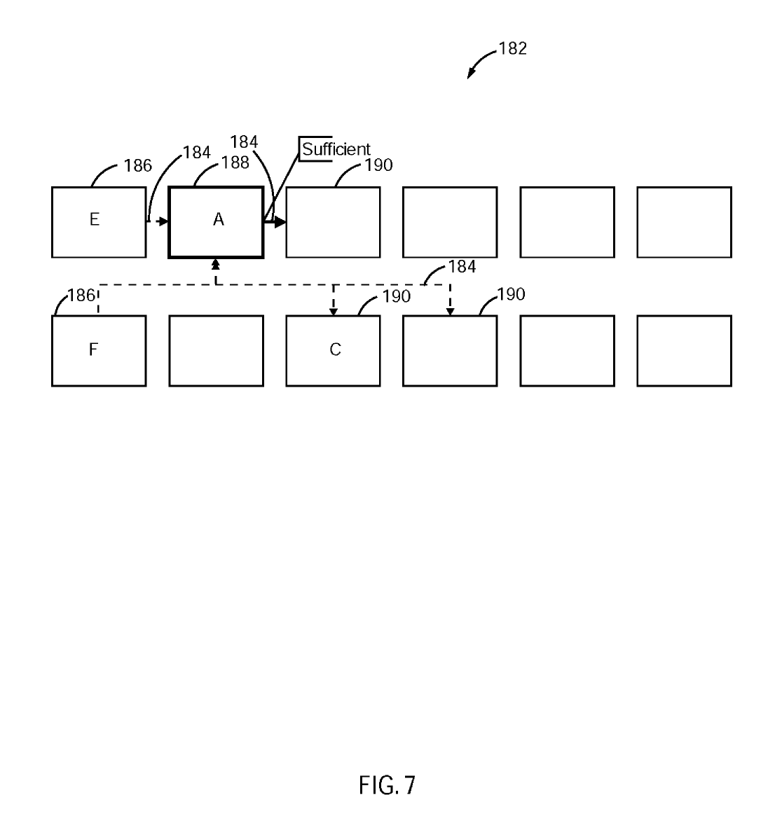

A visualization method for implementing the activity interaction matrix 104 includes a ‘successor activity to activity’ relationship diagram 166 shown in FIG. 5 that describes the discrete-event dynamic system using a set of overlay arrows 168 to represent the plurality of possible relationships between the start of a selected activity 170 and the start of a set of any other activities 172 after the completion of the selected activity 170. The activity interaction matrix 104 further includes a ‘predecessor activity to activity’ relationship diagram 174 shown in FIG. 6 that describes the discrete-event dynamic system using a set of overlay arcs 176 to represent the plurality of possible relationships between the start of a set of other activities 178 that may trigger the start of a selected activity 180. A ‘predecessor and successor activity to activity’ relationship diagram 182 shown in FIG. 7 is further included in the activity interaction matrix 104 that describes the discrete-event dynamic system using a set of overlay arcs 184 to represent the start of a set of other activities 186 that may trigger the start of a selected activity 188 and also the start of a set of any other activities 190 after the completion of the selected activity 188.

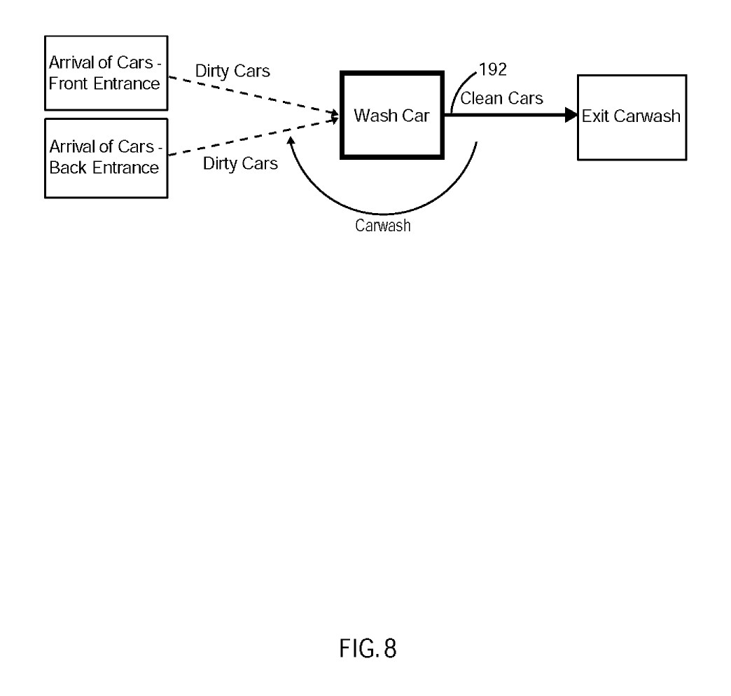

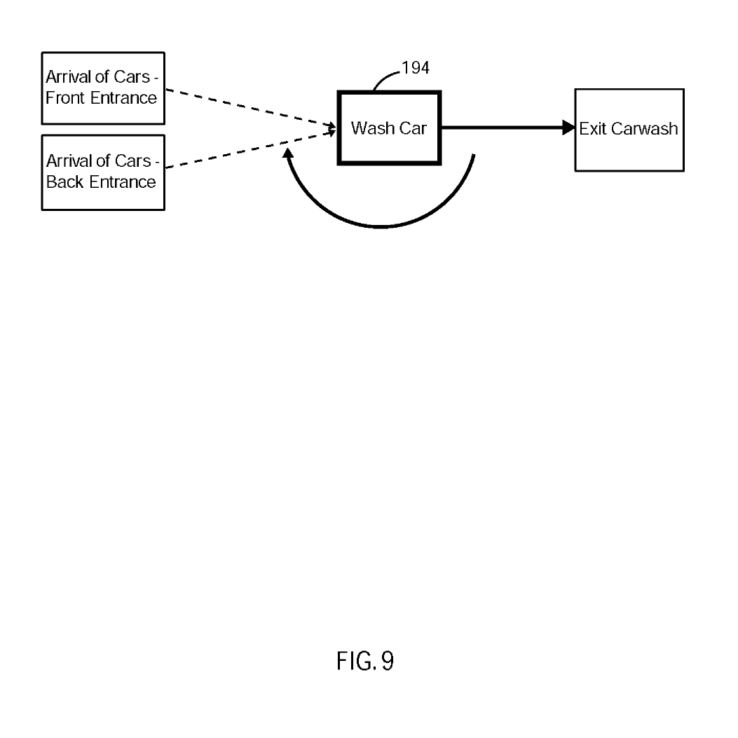

FIG. 8 is another possible embodiment of a ‘predecessor and successor activity to activity’ relationship diagram 182 of FIG. 7 where the entities required and released are indicated on the arcs 192. FIG. 9 is a another possible embodiment of the ‘predecessor and successor activity to activity’ relationship diagram 182 of FIG. 7 that shows the comparative number of the total number of status value conditions satisfied by the selected activity 194 to a total number of status value conditions to start the selected activity 194 through a visual indication—in this case, by indicating the values of N(a,b), C(a) and N(a,b)/C(a) as a percentage.

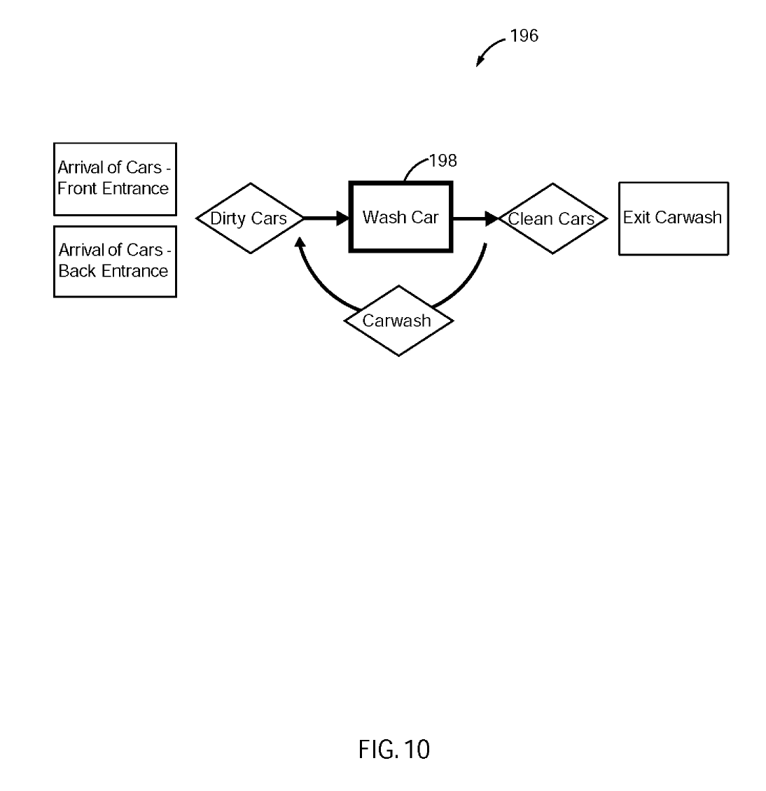

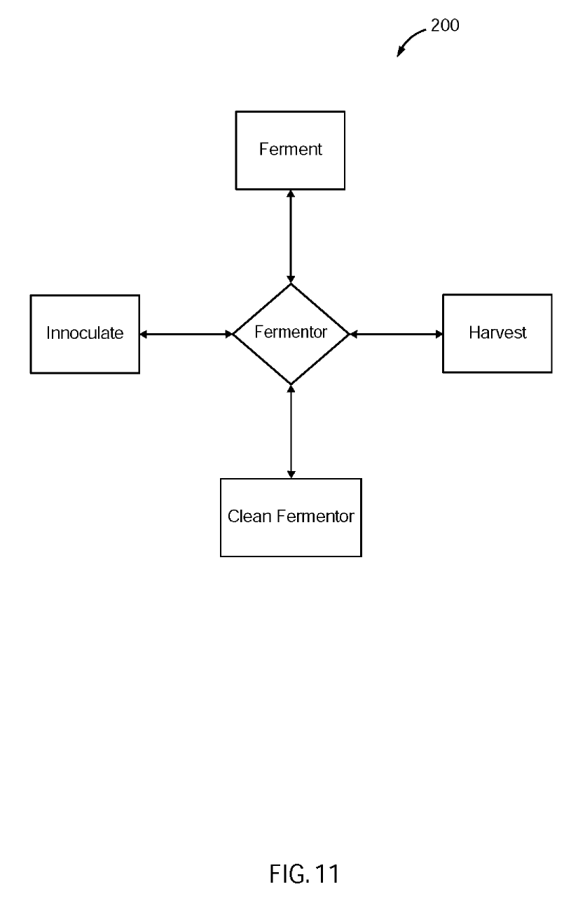

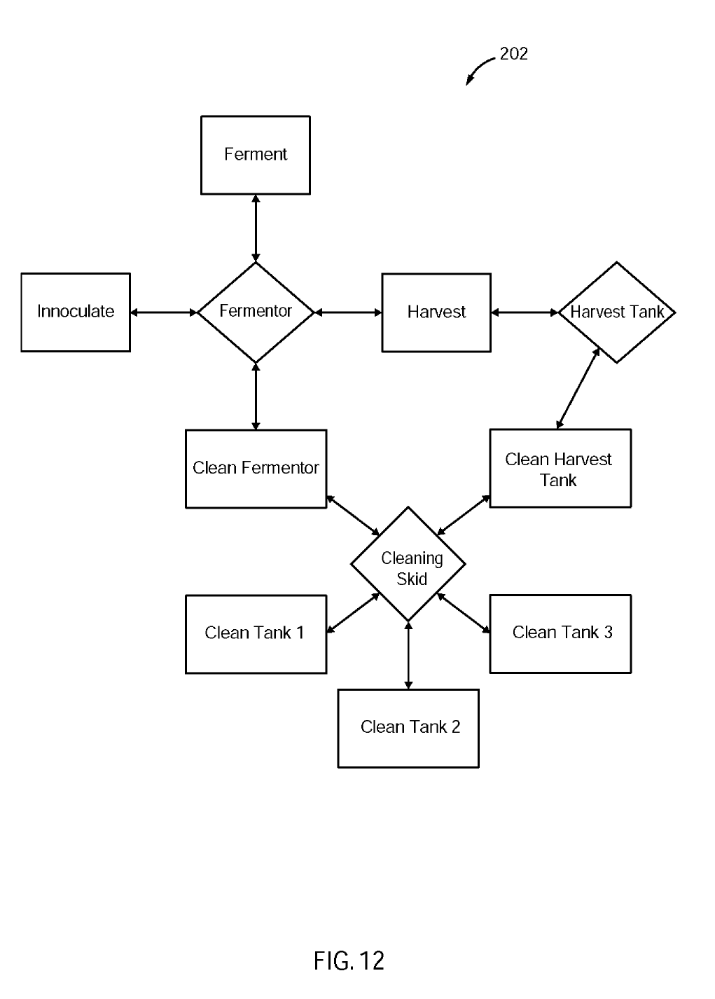

The activity interaction matrix 104 furthermore includes an ‘activity to entity’ relationship diagram 196 shown in FIG. 10 that describes the set of system element status values and the list of system element status value conditions to explicitly illustrate the nature of a specific activity 198. An ‘entity to activity’ relationship diagram 200 of activity interaction matrix 104 shown in FIG. 11 describes the plurality of possible relationships between the system elements and the activity, and an ‘activity to entity to activity’ relationship diagram 202 shown in FIG. 12 describes a set of dependent activities and a plurality of possible relationships between the set of dependent activities through an element-activity cycle.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

We claim:

1. A method for modeling and simulating a discrete-event dynamic system, comprising the steps of:
expressing an algorithm that models a plurality of activity interactions in the discrete-event dynamic system;
determining a plurality of possible relationships between a plurality of system elements including transient entities, resident entities, or both associated in the discrete-event dynamic system, both explicit and implied using the algorithm;
providing a hierarchical mapping of the plurality of system elements and the plurality of possible relationships among the plurality of system elements;
representing a relationship diagram in graph notation where an activity or a system element is visualized as a node and the plurality of possible relationships among the activity or the system element as an arc;
allowing an explicit description of the plurality of possible relationships among the activity or the system element and a plurality of possible ways in which the activity can begin and a sequence of activities that may occur during and after the completion of the activity; and
representing an activity interaction matrix used to categorize the plurality of activity interactions.
whereby the relationship diagram treats every possible logical and physical component including transient entities, resident entities, or both identically as the system element in modeling and simulating complex relationships between the sequence of activities and the plurality of system elements in the discrete-event dynamic system.

2. The method of claim 1 wherein the method considers a concurrent interaction of the plurality of system elements and contention of the activity thereby enabling fast simulation and modeling of a large-scale system having a plurality of indirectly linked processes.

3. The method of claim 1 wherein every change in the system element is modeled by the changes in a set of status values that includes a plurality of possible physical state and a plurality of possible logical state of the discrete-event dynamic system at any point in time.

4. The method of claim 4 wherein the activity is considered as initiated when the set of status values of a specific set of system elements is within a specified set of status values.

5. The method of claim 1 wherein the relationship diagram may be used for at least one of activity sequencing, contention for the plurality of system elements among different activities, concurrent system elements required by activities, and visualization of a simulation.

6. The method of claim 1 wherein the activity can be any dynamic interaction of the system element of any duration.

7. The method of claim 1 wherein the activity may trigger other activities only through changing a specific set of system elements that are related to activities sharing those elements.

8. The method of claim 1 wherein for a specific activity, the relationship diagram segments the plurality of system elements interacting in the specific activity into a list of system element status value conditions required to initiate the specific activity and a list of system element status value changes as a result of the specific activity or during the specific activity.

9. The method of claim 8 wherein a starting condition for the specific activity by the relationship diagram segmentation is represented as
$${\prod }_{i} {I}_{j} ( {f}_{i} ( x ) = true ) = 1 ,$$
and wherein:
x is the vector of a current system element status value at a particular point in the execution of the simulation of an activity j;
f(x) is a function representing each status value condition that returns true if the conditions are present to initiate the activity j, Iⱼ(fᵢ(x)=true) is an indicator function for the activity j when a status value condition i is true, and all of these conditions must be true in order for the activity to initialize.

10. The method of claim 1 or 9 wherein during the execution of the activity j, at least one change can occur to a set of status values which may cause a set of another activities to be placed on a pending activity list that can be described as:
$${\prod }_{i} {I}_{k} ( {f}_{i} ( x + X ) = true ) = 1$$
where k is an activity that is scheduled due to the activity j when at least one of the status value conditions for commencing activity k may be met by the execution of the activity j.

11. The method of claim 1 wherein the relationship diagram categorizes the plurality of activity interactions in a simulation as sufficient, necessary, insufficient and unrelated on the basis of a set of status values of one or more system elements.

12. The method of claim 11 wherein a specific activity is considered to be a sufficient activity if the specific activity makes at least one of the status value conditions that are sufficient to start another activity.

13. The method of claim 11 wherein a specific activity is considered to be a necessary activity when the specific activity has at least one of the status value conditions that are required to start another activity and when the specific activity is the only dependable activity for the another activity.

14. The method of claim 11 wherein a specific activity is considered to be an insufficient activity if the specific activity is neither necessary nor sufficient.

15. A method and an algorithm for determining a plurality of possible relationships between a plurality of activities caused by a set of shared system elements, comprising the steps of:
representing a relationship diagram as a graph notation where an activity or a system element is visualized as a node and a plurality of possible relationships among the activity or the system element as an arc, the system elements including transient entities, resident entities, or both associated in a discrete-event dynamic system;
initializing the algorithm with an empty set of activity-to-activity pairs S(k) requiring a system element k, k=1 . . . K;
populating S(k) with a set of activity-to-activity pairs containing a list of arcs in the relationship diagram relating to the system element k;
initializing a variable C(a) which is defined as the total number of status value conditions to start an activity a, for each start of the activity a, a=1 . . . A;
iterating over a set of possible activity pairs a=1 . . . A with changes in a set of system element status values matched by possible conditions for each activity b, b=1 . . . B;
initializing a variable N(a,b) for each activity pair {a, b} that is defined as the total number of status value conditions satisfied by activity a, by changes in the set of system element status values caused by activity b;
iterating over each of the system element k=1 . . . K in order to determine N(a,b);
determining if the activity a requires the system element k to start and then determining if a status value condition j becomes true through change of the system element k so as to increment N(a,b) as N(a,b)=N(a,b)+1 wherein S(k)=S(k) U {a, b}; and
determining the total number of status value conditions satisfied N(a,b) against the total number of status value conditions C(a) after iterating through a set of possible system elements and a set of status value conditions on the activity a wherein if N(a,b)=C(a), then the set of possible status value conditions are satisfied and the activity b is considered to be sufficient to start the activity a, if N(a,b)=0 then the activity b is unrelated to the activity a, and If 0<N(a,b)<C(a) then at least one of the status value conditions to start the activity a is satisfied by the activity b. Otherwise, activity b is unrelated to activity a.

16. The method of claim 15 wherein the method considers a concurrent interaction of the set of shared system elements and contention of the activity thereby enabling fast simulation and modeling of a large-scale system having a plurality of indirectly linked processes.

17. A method and an algorithm for representing an activity interaction matrix used to categorize a plurality of activity interactions as a sufficient activity, a necessary activity, and an insufficient activity for modeling and simulating complex relationships between a plurality of activities and a plurality of system elements in a discrete-event dynamic system, comprising the steps of:
determining if a plurality of system element status value conditions for one activity in relationship to another activity are true entirely, then stating a starting condition for an activity as sufficient;
determining if the activity has at least one of the status value conditions that are required to start another activity and if the activity is the only dependable activity for another activity, then stating a starting condition for the activity as necessary;
determining if the activity does not fall into the category as necessary activity and sufficient activity in relationship to another activity, then stating a starting condition for the activity as insufficient;
otherwise determining that the activity is neither necessary, sufficient, or insufficient in relationship to another activity and therefore unrelated.

18. The method of claim 17 wherein the plurality of system elements includes transient entities, resident entities, or both associated in the discrete-event dynamic system.

19. The method of claim 17 wherein the activity interaction matrix is generated based on a relationship diagram represented as a graph notation where at least one of either the activity or a system element is visualized as a node and a plurality of possible relationships among the activity or the system element as an arc.

20. The method of claim 19 wherein a visualization method for implementing the activity interaction matrix comprises a ‘successor activity to activity’ relationship diagram that describes the discrete-event dynamic system using a set of overlay arrows to represent a plurality of possible relationships between the start of a selected activity and the start of a set of any other activities after the completion of the selected activity.

21. The method of claim 19 wherein a visualization method for implementing the activity interaction matrix comprises a ‘predecessor activity to activity’ relationship diagram that describes the discrete-event dynamic system using overlay arcs to represent the plurality of possible relationships between the start of a set of other activities that may trigger the start of a selected activity.

22. The method of claim 19 wherein a visualization method for implementing the activity interaction matrix comprises a ‘predecessor and successor activity to activity’ relationship diagram that describes the discrete-event dynamic system using overlay arcs to represent the start of a set of other activities that may trigger the start of a selected activity and also the start of a set of any other activities after the completion of the selected activity.

23. The method of claim 19 wherein a visualization method for implementing the activity interaction matrix comprises an ‘activity to entity’ relationship diagram that describes a set of system element status values and a list of system element status value conditions to explicitly illustrate the nature of a specific activity.

24. The method of claim 19 wherein a visualization method for implementing the activity interaction matrix comprises an ‘entity to activity’ relationship diagram that describes a plurality of possible relationships between the system elements and the activity.

25. The method of claim 19 wherein a visualization method for implementing the activity interaction matrix comprises an ‘activity to entity to activity’ relationship diagram that describes a set of dependent activities and a plurality of possible relationships between the set of dependent activities through an element-activity cycle.
